(19) United States
(12) Patent Application Publication
(10) Pub. No.: US 2016/0231995 A1
(43) Pub. Date: Aug. 11, 2016

(54) INVERTER HAVING PROGRAMMING INTERFACE

(71) Applicant: FRONIUS INTERNATIONAL GMBH, Pettenbach (AT)

(72) Inventors: Robert Reder, Niederneukirchen (AT); Ernst Baumgartinger, Ohlsdorf (AT); Christoph Mayer, Wels (AT); Joachim Jungreithmeier, Eferding (AT); Peter Kardos, Wels (AT)

(21) Appl. No.: 14/891,324

(22) PCT Filed: May 14, 2014
(86) PCT No.: PCT/EP2014/059879

§ 371 Date: Apr. 5, 2016

(30) Foreign Application Priority Data
May 16, 2013 (AT) A 411/2013

(51) Int. Cl. G06F 9/445; H04L 29/08

(52) U.S. Cl. CPC G06F 8/65; H04L 67/34

(57) ABSTRACT

Inverter for converting a DC voltage to an AC voltage, comprising an inverter controller which is connected to a programming interface of the inverter via which inverter software components can be downloaded.

The invention relates to an inverter having a programming interface and in particular to an inverter for a photovoltaic system.

Inverters are devices which convert a DC voltage to an AC voltage. Inverters are primarily used in photovoltaic systems in order to convert the direct current generated by photovoltaic modules to a single-phase or multi-phase alternating current. Further fields of application for inverters include uninterruptible power supplies, frequency converters or lighting devices. Different inverters which differ not only in their mode of operation but also in their nominal power are used in photovoltaic systems. Each inverter is suitable for a particular power range. Primarily, the AC and DC nominal powers are significant for the mode of operation of the inverter. In a photovoltaic system, a multiplicity of solar modules can be connected in series with each other and, in this manner, can form a string of solar modules. In the case of smaller photovoltaic systems which comprise a relatively small number of solar modules, solar modules are connected in series and are connected to a central inverter. In the case of larger photovoltaic systems, so-called string inverters are used.

Furthermore, inverters differ in terms of their degree of efficiency. In order for a photovoltaic system to operate in a maximum power range, i.e. to produce as much electrical current as possible, a so-called Maximum Power Point (MPP) tracker can additionally be integrated in the inverter. The power supplied by a photovoltaic system varies during the course of the day depending on environmental factors, such as, for example, solar radiation, temperature and whether the solar modules are in the shade. The MPP tracker integrated in the inverter performs auto-adjustment of the inverter for maximum current yield or the best possible function of the inverter, by continuously adapting the voltage.

Depending upon the implementation, inverters can provide AC voltages of different shapes, in particular a rectangular voltage, a trapezoidal voltage or a sinusoidal voltage.

The circuit design and the functions provided by the different inverters of the photovoltaic system can thus vary.

Some conventional inverters also have data interfaces which allow photovoltaic system data to be read from the inverter and further processed. For example, conventional inverters are fitted with an RS232 or RS422 data interface which allow data to be read from the inverter at an adjustable baud rate. A PC can be connected, for example, to the serial data interface of the inverter for data evaluation.

Conventional inverters have an inverter controller integrated therein which runs predetermined control software during operation of the inverter. The control software is hard-implemented in order to provide the main functions of the inverter. The conventional inverter thus uses a standard inverter control software which is not adapted to the individual configuration of the respective system and cannot provide individual additional functions desired by the respective user.

It is thus an object of the present invention to provide an inverter for a system which allows the scope of function of the inverter to be easily adapted to the individual requirements of the system and/or system operator.

In accordance with the invention, this object is achieved by an inverter having the features stated in claim 1.

The invention thus provides an inverter for converting a DC voltage to an AC voltage, wherein the inverter comprises an inverter controller which provides a programming interface via which inverter software components can be downloaded.

In one possible embodiment of the inverter in accordance with the invention, the programming interface of the inverter is connected to a server via a data network so as to download inverter software components.

In a further possible embodiment of the inverter in accordance with the invention, the programming interface is connected to a reading unit for reading out the inverter software components from a data carrier.

In a further possible embodiment of the inverter in accordance with the invention, the inverter software component downloaded via the programming interface of the inverter is initially checked for its admissibility and/or safety.

In a further possible embodiment of the inverter in accordance with the invention, the inverter software component downloaded via the programming interface of the inverter is loaded or written in a program memory of the inverter if the inverter software component is classified as being admissible and/or safe.

In a further possible embodiment of the inverter in accordance with the invention, the inverter software component downloaded via the programming interface of the inverter is checked for the validity of a certificate of the inverter software component and, if the certificate is classified as being valid, the inverter software component is loaded in the program memory of the inverter.

In a further possible embodiment of the inverter in accordance with the invention, an inverter software component is selected and/or retrieved for execution via a user interface of the inverter.

In a further possible embodiment of the inverter in accordance with the invention, the inverter software component downloaded via the programming interface of the inverter monitors an operating state of the inverter and, in the event of a particular operating state of the inverter, reports this operating state in a data format and/or data transmission protocol specified in the respective inverter software component to a node of a data network to which the inverter is connected.

In a further possible embodiment of the inverter in accordance with the invention, a functionality implemented in the inverter is unlocked by the inverter software component downloaded via the programming interface of the inverter.

In a further embodiment of the inverter in accordance with the invention, the inverter software component downloaded via the programming interface of the inverter has access to data which are locally available at the respective inverter, in particular to locally available sensor or measuring data.

In a further possible embodiment of the inverter in accordance with the invention, the inverter software component downloaded via the programming interface of the inverter has access to data which are globally available in the data network, in particular system data and measuring or sensor data of the respective system.

In a further possible embodiment of the inverter in accordance with the invention, the inverter software component downloaded via the programming interface of the inverter is interpreted in a sandbox environment by an interpreter.

In a further possible embodiment of the inverter in accordance with the invention, the inverter software component downloaded via the programming interface of the inverter is executed in a sandbox environment as machine code.

According to a further aspect of the invention, the invention provides a photovoltaic system having the features stated in claim 12.

The invention thus provides a photovoltaic system having at least one inverter which is provided to convert a DC voltage to an AC voltage, wherein the inverter has an inverter controller which is connected to a programming interface of the inverter, via which inverter software components can be downloaded, wherein the photovoltaic system further comprises at least one photovoltaic module which supplies a DC voltage which is converted by the inverter to an AC voltage which the inverter feeds into a voltage supply grid.

In one possible embodiment of the photovoltaic system in accordance with the invention, the programming interfaces of the inverters of the photovoltaic system are connected to a data network which connects the inverters of the photovoltaic system to a remote server which provides inverter software components to be downloaded by the inverters of the photovoltaic system.

In one possible embodiment of the photovoltaic system in accordance with the invention, the programming interface of an inverter of the photovoltaic system automatically produces a data connection to a preconfigured network address of a server of the data network which provides the inverter software components to be downloaded by the respective inverter.

In a further possible embodiment of the photovoltaic system in accordance with the invention, an inverter type and/or an inverter identity and/or an inverter location of the respective inverter is automatically transferred by the programming interface of the inverter via the data network to the server for providing inverter software components suitable therefor.

Possible embodiments of the inverter in accordance with the invention will be described in more detail hereinafter with reference to the attached figures, in which:

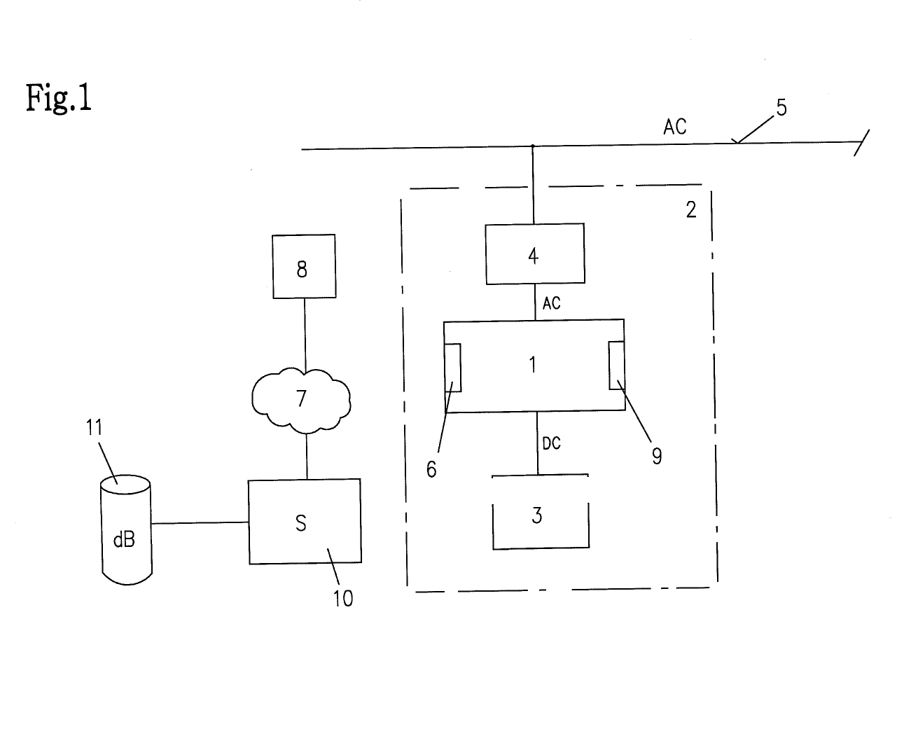

FIG. 1 shows a block diagram of a simple photovoltaic system which comprises an inverter in accordance with the invention;

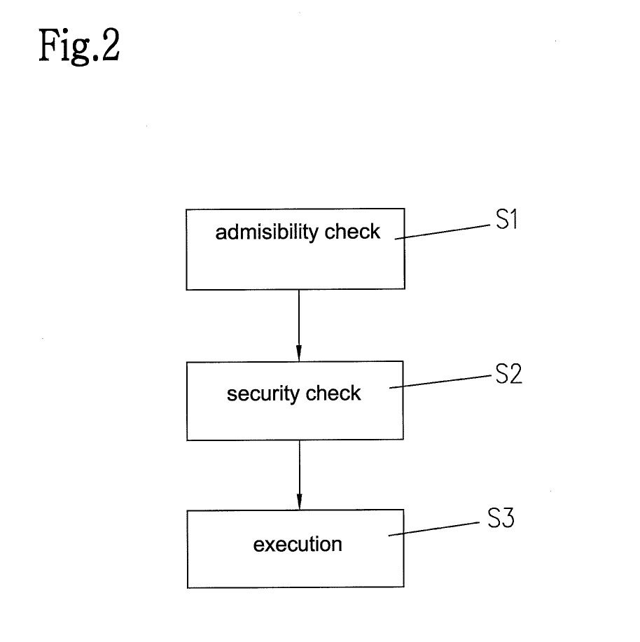

FIG. 2 shows a flow diagram for explaining the mode of operation of one possible embodiment of the inverter in accordance with the invention;

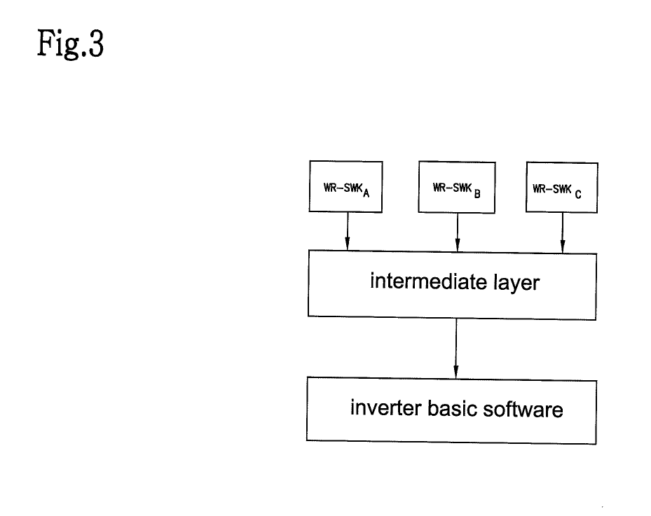

FIG. 3 shows a schematic view for explaining the mode of operation of one possible embodiment of the inverter in accordance with the invention.

As can be seen in FIG. 1, an inverter 1 in accordance with the invention can be used in a photovoltaic system 2. The photovoltaic system 2 has solar modules 3 which can be connected in parallel in one or more strings and which supply a direct current DC or a DC voltage, as shown in FIG. 1. The inverter 1 converts the DC voltage to an AC voltage or an alternating current AC and feeds the produced alternating current AC into a power supply grid 5, e.g. via a feed-in meter 4. The inverter 1 can be an externally commutated inverter or a line-commutated inverter which is provided to feed electrical energy from the DC voltage side into the AC grid. In one possible embodiment, the inverter 1 is also designed to draw energy from the power supply grid 5 in the reverse direction and to convert it to DC voltage. In one possible embodiment, the inverter 1 is further configured to recognise grid disruptions should they occur and to at least partially switch off the photovoltaic system 2 in that event. In this manner, overvoltages in a switched-off grid section are avoided. Instead of solar modules, the system 2 can also comprise, for example, fuel cells or the like which supply DC voltage. The exemplified embodiment illustrated in FIG. 1 is a line-commutated inverter 1. Alternatively, the inverter 1 can also be a self-commutated inverter which has auto-switch-off current valves, e.g. transistors or IGBTs, which are switched on and off by a clock signal which is produced locally by a clock of the inverter 1.

The inverter 1 illustrated in FIG. 1 can produce a single-phase or multi-phase alternating current and feed same into the power supply grid 5. The signal shape of the produced alternating current can vary. In one possible embodiment, the produced alternating current is sinusoidal.

As shown in FIG. 1, the inverter 1 comprises a programming interface 6 which, in the illustrated exemplified embodiment, is connected to a data network 7. The connection between the programming interface 6 and the data network 7 can be wired, as shown in FIG. 1. Alternatively, a wireless connection between the data network 7 and the programming interface 6 is also possible. The data network 7 can be a local data network, such as a Local Area Network of a system, in particular an industrial system. Furthermore, the data network 7 can be an extensive network or an interconnection of networks. In one possible embodiment, the data network 7 is formed by the Internet. As illustrated in FIG. 1, a terminal 8 can be connected to a node of the data network 7 and can be operated by a user of the system 2. In one possible embodiment, the inverter 1 itself comprises a user interface, e.g. a Graphical User Interface GUI 9. In addition to the terminal 8, a server 10 is connected to the data network 7 and has access to a database 11. This database 11 can contain a multiplicity of different inverter software components which can be loaded into the inverter 1 as required by a user of the system 2 via the programming interface 6. In one possible embodiment, the inverter 1 has, when it is delivered, a basic configuration of software components in order to perform basic functions or main functions within the system 2. This basic software of the inverter 1 can be stored in a programming memory of the inverter 1. The programming interface 6 of the inverter 1 can be used to expand the main or basic functions of the inverter 1 with individual additional functions in order to correspond to the individual configuration of the system 2 and/or meet the requirements of the user. The inverter software components which are contained for example in the database of the server 10 can be developed by end users of different systems 2, in particular by users of photovoltaic systems, or by third parties, and can be transferred to the server 10 so as to be stored in its database 11. For example, inverter software components can be generated by an operator of a photovoltaic system at the terminal 8 of the photovoltaic system 2 and can be transferred via the data network 7 to the server 10 so as to be stored in the database 11. It is further possible that a manufacturer of the inverter 1 produces suitable inverter software components, associated with different types of inverters 1 produced by the manufacturer, for different additional functions and provides them in the database 11 for loading. It is further possible that each inverter 1 has an individual inverter identity or inverter designation, for which inverter software components, which are suitable in each case, are stored in the data memory 11. The inverter software components stored in the database 11 thus originate from a manufacturer of the inverter 1 or of the photovoltaic system 2 and from users of the system 2 or from third parties, e.g. engineering consultants or the like.

A user of the system 2 has the option of making an input via the user interface 9 of the inverter 1 in order to select a desired inverter software component and download it into the respective inverter 1 for immediate or subsequent execution. Alternatively, the desired inverter software component can also be selected via the terminal 8 of the system 2. The generated inverter software component request is transmitted to the server 10 via the data network 7. Preferably, identity information regarding the requesting inverter 1 and/or system 2 is additionally transmitted therewith. The identity of the inverter 1 and/or the photovoltaic system 2 is checked or verified by the server 10. The server 10 can be operated, for example, by the manufacturer of inverters 1 and/or photovoltaic systems 2. For example, the manufacturer can operate a service portal for a library or collection of inverter software components.

In order to ensure the safety and operational readiness of the system 2, in a preferred embodiment the inverter software component downloaded via the programming interface 6 is initially checked for its admissibility and then for its safety, as illustrated in FIG. 2. Prior to loading an inverter software component from the server 10 via the programming interface, an admissibility check of the respective inverter software component is initially performed in a step S1. For example, power supply grids 5 have different fundamental frequencies in different countries. This fundamental frequency is 50 Hz, for example, in Germany or Austria. In other countries, the fundamental frequency of the power supply grid is different therefrom. If the inverter software component influences e.g. the adjustment of the frequency of the AC voltage or alternating current AC fed by the inverter 1 into the power supply grid 5, a check module of the inverter 1 can check in step S1 whether the requested inverter software component is admissible or suitable in the respective country in which the power supply grid 5 is located. For example, an inverter software component may be suitable or admissible for an inverter 1 located in the USA whilst it is inadmissible or unsuitable for another inverter 1′ located in Germany or Austria.

In one possible embodiment of the inverter 1 in accordance with the invention, the programming interface 6 of the inverter 1 automatically produces a data connection to a preconfigured network address of a server 10 of the data network 7. This network address can be, for example, an IP network address or a URL (Uniform Resource Locator). This server network address can be preconfigured in a memory of the inverter 1, so that a data connection to a particular server 10 is automatically produced, the desired inverter software components being able to be loaded from the database 11 of said server. Depending upon the configuration and/or location of the inverter 1, an automatic connection to an associated server 10 can be produced within the data network 7. If, for example, the inverter 1 is set-up or delivered in a particular country, the programming interface 6 produces a data connection to the network address of a server 10 which has access to inverter software components which are suitable for the respective country or for the power supply grid 5 thereof.

In a preferred embodiment of the inverter 1 in accordance with the invention, after the admissibility check S1 a safety check is performed in a further step S2 in order to determine whether the downloaded inverter software component ensures safe operation of the inverter 1 and the system 2. In one possible embodiment of the inverter 1 in accordance with the invention, the inverter software component downloaded via the programming interface 6 of the inverter 1 is checked for the validity of a certificate of the inverter software component. Only when the validity of the certificate is recognised is the requested inverter software component loaded, for example, in a program memory of the inverter 1 for immediate or subsequent execution. The downloaded inverter software components or inverter modules can expand or replace basic functions of the inverter 1. For example, a hybrid inverter can be produced from a simple inverter by accessing certified inverter software components. Retrofitting on further developed or other device types of the inverter 1 can also be effected by downloading corresponding certified inverter software components. The inverter software component downloaded via the programming interface 6 can unlock or expand, for example, a functionality already provided in the inverter 1.

If the admissibility check in step S1 and the safety check in step S2 are successful, the loaded inverter software components can be executed in step S3, as shown in FIG. 2. In one possible embodiment, the inverter software component loaded via the programming interface 6 of the inverter 1 is interpreted by an interpreter. In one embodiment variant, the programming interface 6 is programmed in a dedicated proprietary programming language. In this embodiment variant, only commands which are known to the respective interpreter can be used. On the other hand, it is ensured that only one inverter 1 which has a corresponding interpreter can interpret and execute the corresponding inverter software component.

In an alternative embodiment variant, the software component downloaded via the programming interface 6 is executed as machine code and, optionally, as assembler code. The access to data and control elements can be effected in this case, for example, via a library. The library can take on a majority of the admissibility and safety check. Furthermore, the application or inverter software component can be stored in a dedicated shadow-copied rootfs in order to conceal the operating system. In one possible embodiment, both variants are combined in order to increase the safety and flexibility of the inverter 1. For example, a python script can be interpreted in a dedicated sandbox environment.

The inverter software components or inverter software applications can either be used in a public, private or proprietary manner. The inverter software components can be published, for example, via an on-line portal of the manufacturer. The user of a system 2, in particular a photovoltaic system, has the option of importing, via this on-line portal, the inverter software components which are suitable for his system 2 and meet his needs, via the programming interface 6.

In a further possible embodiment of the inverter 1 in accordance with the invention, the inverter comprises a reading unit for reading out inverter software components from a data carrier, e.g. a USB stick.

An example of a programming interface 6, as can be used in an inverter 1 in accordance with the invention, is described hereinafter:

double const HAR_VALUE = numeric_limits<double>::quiet_NON( ):
namespace Devices
{

///Get list of active devices
static void GetList(vector<string> & aDeviceIdList):
///Query Current Values
static void QueryCurrentInverterValues(string const aDeviceId, vector<int> const&

aSetOfRequestedChannels, vector<double> & aSetofValues);

///inverter states
enum inverter_state_t { Undetectable = 0,

Off = 1,
Sleeping = 2,
Standby = 3,
Starting = 4,
Shutdown = 5,
Running = 6,
Fault = 7,
Throttled = 8,
CommFault = 9

};

///Get Inverter State
static void GetState(string const aDeviceId, Inverter_state_t & aState);
///Set Inverter State
static bool SetState(string const aDeviceId, inverter_state_t const aState);

}
namespace Features
{

| | | |
|---|---|---|
| enum feature_state_t { Requ [symbol] ed = 1, | //needed | |
| | Available = 2, | //supported |
| | Disabled = 3, | //unsupported |
| | Optional = 4, | //unused |
| | ForcedOff = 5 | //Incompatible |

};

class FeatureBase {
public:

FeatureBase( ){
}
virtual [symbol] FeatureBase( ){
}
feature_state_t state;
enum type_t ( Base, Int, Double );
virtual type_t getType( ){

return Base;

}

};
class FeatureInt : public FeatureBase{
public:

uint32_t value:
type_t getType( ){

return Int;

}

};
class FeatureDouble : public FeatureBase {
public;

double value;
type_t getType( ){

return Double;

}

};
//Get system dependend features (serials, ids. pmc, devicetyp, ratings, powerstage features....)
static void Query(string const aDeviceId, int const aFeatureDescriptor, FeatureBase [symbol] aFeature);

}
namespace Throttle
{

//Power Throttle Functions
struct point_t {

Int throttleValue;
Int dependenySource:

};
enum throttle_dependency_t { None,

BasedOnPln, //abhangig von PV
BasedOnVac, //abhangig von Netz
BasedOnTemperature, //abhangig von Temp
BasedOnExternal //abhangig von Externen

Komponenten (pins...)
}:

| | |
|---|---|
| enum throttle_mode_t { Static, | //die Konfiguration gilt dauerhaft (auch nach neustart |
| des LT) | |
| | Dynamic //gilt nur fur eine gew [symbol] se dauer |

Und wird nach neustart von LT nicht reinitialistert
};

| | |
|---|---|
| enum throttle_type_t { P, | //Fahre eine Leistungskennlinie |

| | |
|---|---|
| CosPht, | //Fahre eine CosPhi Kennlinie |
| Qrel | //Fahre einen relativen BI IndanteII |

};

struct throttle_config_t {

| | |
|---|---|
| throttle_dependency_t | Dependency; |
| throttle_mode_t | VolatileState; |
| throttle_type_t | Type; |
| int | CharacteristicGradient; |
| int | StartInSeconds; |

| | |
|---|---|
| int | ActiveDuration; |
| }; | |

//return −1 on failure/not supported or number [symbol] 0 if succedded
static int Set(throttle_config_t const& config, vector<point_1> const& aChart);
//return true on success
static bool Reset(int const& ThrottleId);

} [symbol]
indicates data missing or illegible when filed

In one possible embodiment, the interface or the programming interface 6 has access to all available system and measuring data in the respective system. In one possible embodiment, the inverter software components downloaded via the programming interface 6 have access to data, in particular sensor or measuring data of the inverter 1, which are locally available at the respective inverter 1. In a further possible embodiment, the inverter software components downloaded via the programming interface 6 have access to data, in particular system and measuring data which are globally available in the data network 7, or to data which are provided by web services.

In one possible embodiment of the inverter 1 in accordance with the invention, only certified inverter software components which pass the safety check in step S2 of figure are loaded in an integrated program memory of the inverter 1 for execution. Certification of the software components can be performed, for example, by a manufacturer of the inverter 1 or by any other certifying body. In one possible embodiment, the inverter software component comprises a digital signature which can be checked using a compatible public key. This public key is signed by a trustworthy body so that it is possible to verify its authenticity. This signing body forms the certifying body or Certification Authority CA. The certificate of the inverter software component forms the public key signed by the certifying body with the associated digital signature and possible additional parameters. In one possible embodiment, a so-called Trust Center generates and manages the certificates and associated restriction lists. The Trust Center can effect the key generation and digital signatures. The certificate is generally generated by the certifying body and contains the public key of the signatory and the signature of the certifying body. In one possible embodiment, the inverter 1 can load certified as well as uncertified inverter software components, but it is ensured that the uncertified inverter software components cannot influence any important or safety-critical functions.

FIG. 3 schematically shows a structure of a software system which is used by the inverter 1 in accordance with the invention. The software system comprises a plurality of layers, wherein inverter software components WR-SWK or inverter applications have access to inverter basic functions or basic software components via an intermediate layer. The intermediate layer forms an abstraction and safety layer which ensures that user applications or inverter software components WR-SWK cannot directly access the basic functions of the inverter 1. The abstraction and safety layer performs the safety check in step S2.

In one possible embodiment of the inverter 1 in accordance with the invention, the inverter software component loaded via the programming interface 6 monitors an operating state of the inverter 1. In the event of a particular operating state, this operating state is reported to a node of the data network 7. This node can be, for example, a monitoring node of the respective system. In one possible embodiment, this operating state is reported in a data format and/or data transmission protocol specified in the inverter software component to the node of the data network 7. For example, a user may wish to be informed about certain states of the inverter 1 and/or the system 2 and specify the states and format and mode of transmission of this information itself. In this case, it is possible for the user to develop a corresponding dedicated software module or a corresponding inverter software component which monitors the operating state of the inverter 1 and, in the event of an error, forwards this error to a particular end node in the data network 7 of the user. The node can also be a network-compatible display device which displays the current operating data of the inverter 1.

If a user has developed a suitable inverter software component, for example at his terminal 8, he can allow these inverter software components to be used by other users by uploading them, for example, to an on-line portal of the server 10. In one possible embodiment, after receiving the inverter software component from a user, the developed inverter software component can be tested by the manufacturer of the inverter 1 which operates the portal. After a successful test, the tested inverter software component can be correspondingly certified by the manufacturer of the respective type of inverter 1 and can be provided so that other users can load it from the server 10. In one possible embodiment variant, a user is informed, prior to downloading an inverter software component, whether or not the respective inverter component has been certified by the manufacturer as being harmless in terms of safety.

In a further possible embodiment, a user has a dedicated data format with which he processes data. Typically, the user already has different tools which read and process the data in this data format. The user of the system 2 may thus wish to also use his data format for the data which originate from the inverter 1 of his system. In this case, the user of the system has the option of developing a dedicated inverter software component or a corresponding software module which encapsulates the data, required thereby, of the inverter 1 in the data format preferred by him and supplies said data for further data processing. The user can then make this inverter software component available to third parties, for example via the portal of the server 10.

The system in accordance with the invention can be used to provide inverter software components which support any data transmission protocols, in particular IP-based data transmission protocols. Users can read out, process and send data accordingly via the additional protocols. The integration in larger or more extensive systems is hereby facilitated because the user is no longer dependent on a software manufacturer. This larger system can be, for example, a so-called Mixed Concept system. In a Mixed Concept system, power sections having lower power production are switched off. In this manner, operating hours are saved and the degree of efficiency is increased. By using an inverter software component, a user has the option of converting this functionality so as to meet his own needs and requirements.

For example, a user may require a particular signal if an inverter 1 complies with a set of adjustable or configurable rules. For example, a signal is required if a parametrised power value is not exceeded or not reached over an adjustable time period. Furthermore, a signal may be generated or required if a maximum or minimum value has been reached.

Furthermore, a controlling access to the power production can be permitted using an inverter application, wherein a connection to ripple control receivers or other superordinate control systems can be achieved. A user can use a proprietary protocol by means of an inverter software component, whereby the product can be flexibly incorporated in any system. A user or customer has the option of himself defining compiled elements. A newly defined element can be incorporated as an inverter software component, e.g. as a plug-in, for the Graphical User Interface GUI 9 and/or a website and can be launched. The available inverter software components are predefined and can be applied in an unrestricted manner, e.g. with respect to their position on a display unit, with respect to the displayed values or the displayed graphics, etc. The inverter software components can be compiled on the device. For example, an inverter software component can display a favourites value list or can perform language adaptation. Furthermore, a user of the system 2 can integrate support for his language. It is further possible that a system integrator orders inverters from a manufacturer and adapts them using inverter software components such that his own branding and an associated expansion of the functional scope is displayed. This is achieved, for example, by adaptation using the user interface 9 of the inverter 1. The inverter 1 in accordance with the invention can be used in a photovoltaic system 2, as shown in FIG. 1. The inverter 1 can also be used in other applications or other systems, e.g. in uninterruptible power supply devices or in frequency converters. The inverter 1 can be a module inverter, a string inverter or even a central inverter of a photovoltaic system 2. The inverter software components can use the programming interface 6 provided in the inverter 1 in order to cause an operating system of the inverter 1 to execute the actions provided thereby. The user thus has the option of programming dedicated additional functions and thus has the option of expanding the inverter software components by dedicated functions.

1. Inverter (1) for converting a DC voltage to an AC voltage, comprising an inverter controller which provides a programming interface (6) of the inverter via which inverter software components can be downloaded.

2. Inverter as claimed in claim 1, wherein the programming interface (6) is connected to a data network (7) for downloading the inverter software components from a server (10).

3. Inverter as claimed in claim 1, wherein the programming interface (6) is connected to a reading unit for reading out the inverter software components from a data carrier.

4. Inverter as claimed in any one of the preceding claims 1 to 3, wherein the inverter software component downloaded via the programming interface (6) is checked for its admissibility and safety.

5. Inverter as claimed in claim 4, wherein the inverter software component downloaded via the programming interface (6) is loaded in a program memory of the inverter if it is classified as being admissible and safe.

6. Inverter as claimed in claim 4 or 5, wherein the inverter software component downloaded via the programming interface (6) of the inverter is checked for the validity of a certificate of the inverter software component, before it is loaded in the program memory of the inverter (1).

7. Inverter as claimed in any one of the preceding claims 1 to 6, wherein an inverter software component is selected and retrieved via a user interface of the inverter (1).

8. Inverter as claimed in any one of the preceding claims 1 to 7, wherein the inverter software component downloaded via the programming interface (6) monitors an operating state of the inverter (1) and, in the event of a particular operating state, reports this operating state in a data format and/or data transmission protocol specified in the inverter software component to a node of the data network (7).

9. Inverter as claimed in any one of the preceding claims 1 to 7, wherein the inverter software component downloaded via the programming interface (6) unlocks a functionality implemented in the inverter (1).

10. Inverter as claimed in any one of the preceding claims 1 to 9, wherein the inverter software component downloaded via the programming interface (6) has access to data which are locally available at the inverter (1) and/or are globally available in the data network (7).

11. Inverter as claimed in any one of the preceding claims 1 to 10, wherein the inverter software component downloaded via the programming interface (6) is interpreted in a sandbox environment by an interpreter or is executed as machine code.

12. Photovoltaic system (2) having at least one inverter as claimed in any one of the preceding claims 1 to 11 and at least one photovoltaic module (3) which supplies a DC voltage which is converted by the inverter (1) to an AC voltage which the inverter (1) feeds into a voltage supply grid (5).

13. Photovoltaic system as claimed in claim 12, wherein the programming interfaces (6) of the inverters (1) of the photovoltaic system (2) are connected to a data network (7) which connects the inverters (1) of the photovoltaic system (2) to a remote server (10) which provides inverter software components to be downloaded by the inverters (1) of the photovoltaic system (2).

14. Photovoltaic system as claimed in claim 12 or 13, wherein the programming interface (6) of an inverter (1) automatically produces a data connection to a preconfigured network address of a server (10) which provides suitable inverter software components to be downloaded by the respective inverter (1).

15. Photovoltaic system as claimed in any one of the preceding claims 12 to 14, wherein an inverter type and/or an inverter identity and/or an inverter location of the respective inverter is automatically transferred by the programming interface (6) of the inverter (1) via the data network (7) to the server (10) for providing suitable inverter software components.
